(19) United States
(12) Patent Application Publication
(10) Pub. No.: US 2024/0015850 A1
(43) Pub. Date: Jan. 11, 2024

(54) COMMUNICATION CONTROL METHOD AND USER EQUIPMENT

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 18/472,666

(22) Filed: Sep. 22, 2023

Related U.S. Application Data
(63) Continuation of application No. PCT/JP2022/013265, filed on Mar. 22, 2022.
(60) Provisional application No. 63/164,682, filed on Mar. 23, 2021.

(51) Int. Cl. H04W 76/40; H04W 76/23; H04W 24/08

(52) U.S. Cl. CPC H04W 76/40; H04W 76/23; H04W 24/08; H04L 12/1868

(57) ABSTRACT

In a first aspect, a communication control method is a method used in a mobile communication system for providing a multicast broadcast service (MBS) from a base station to a user equipment. The communication control method includes receiving, by the user equipment, MBS data transmitted from the base station through a transmission scheme of either PTP transmission or PTM transmission; and transmitting, by the user equipment in response to switching of the transmission scheme between the PTP transmission and the PTM transmission, a message to the base station. The message includes information indicating a sequence number of a received packet related to the switching.

### RELATED APPLICATIONS

The present application is a continuation based on PCT Application No. PCT/JP2022/013265, filed on Mar. 22, 2022, which claims the benefit of US Provisional Patent Application No. 63/164682 filed on Mar. 23, 2021. The content of which is incorporated by reference herein in their entirety.

### TECHNICAL FIELD

The present disclosure relates to a communication control method and a user equipment that are used in a mobile communication system.

### BACKGROUND OF INVENTION

In recent years, a mobile communication system of the fifth generation (5G) has attracted attention. New Radio (NR), which is a Radio Access Technology (RAT) of the 5G System, has features such as high speed, large capacity, high reliability, and low latency compared to Long Term Evolution (LTE), which is a fourth-generation radio access technology.

### CITATION LIST

### Non-Patent Literature

Non-Patent Document 1: 3GPP Technical Specification “3GPP TS 38.300 V16.3.0 (2020 September)”

### SUMMARY

In a first aspect, a communication control method is a method used in a mobile communication system for providing a multicast broadcast service (MBS) from a base station to a user equipment. The communication control method includes receiving, by the user equipment, MBS data transmitted from the base station through a transmission scheme of either PTP transmission or PTM transmission; and transmitting, by the user equipment in response to switching of the transmission scheme between the PTP transmission and the PTM transmission, a message to the base station, the message including information indicating a sequence number of a received packet related to the switching.

In a second aspect, a communication control method is a method used in a mobile communication system for providing a multicast broadcast service (MB S) from a base station to a user equipment. The communication control method includes performing, by the user equipment, a PTM monitoring operation that attempts to receive MBS data transmitted from the base station via a PTM communication path; and stopping, by the user equipment, the PTM monitoring operation in response to detecting deterioration in a measurement value indicating communication quality of the PTM communication path.

In a third aspect, a user equipment includes a processor that performs the communication control method according to the first aspect or the second aspect.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a base station (gNB) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating a correspondence relationship between a downlink Logical channel and a downlink Transport channel according to an embodiment.

FIG. 7 is a diagram illustrating a delivery method of MBS data according to an embodiment.

FIG. 8 is a diagram illustrating a split MBS bearer according to an embodiment.

FIG. 9 is a diagram illustrating an operation example related to activation and deactivation of a leg according to an embodiment.

FIG. 10 is a diagram illustrating an operation example of switching from PTP transmission to PTM transmission according to an embodiment.

FIG. 11 is a diagram illustrating a configuration example of an SN notification message according to an embodiment.

FIG. 12 is a diagram illustrating an operation example of switching from PTM transmission to PTP transmission according to an embodiment.

FIG. 13 is a diagram illustrating an operation example related to a PTM monitoring operation according to an embodiment.

FIG. 14 is a diagram illustrating PDCP anchored PTM/PTP switch based on current agreement.

FIG. 15 is a diagram illustrating PDCP anchored PTM RLC-UM/PTP RLC-UM switch based on agreement.

FIG. 16 is a diagram illustrating an example of A1+B1 of PTM RLC-UM+PTP RLC-AM.

FIG. 17 is a diagram illustrating an example of A2+B1 of PTM RLC-UM+PTP RLC-AM.

FIG. 18 is a diagram illustrating an example of A3+B2 (+B1) of PTM RLC-AM+PTP RLC-AM.

FIG. 19 is a diagram illustrating a summary of possible options for L2 reliability.

### DESCRIPTION OF EMBODIMENTS

Introduction of multicast broadcast services to the 5G system (NR) has been under study. NR multicast broadcast services are desired to provide enhanced services compared to LTE multicast broadcast services.

The present disclosure provides a communication control method that achieves enhanced multicast broadcast services and a user equipment.

A mobile communication system according to an embodiment is described with reference to the drawings. In the description of the drawings, the same or similar parts are denoted by the same or similar reference signs.

Configuration of Mobile Communication System

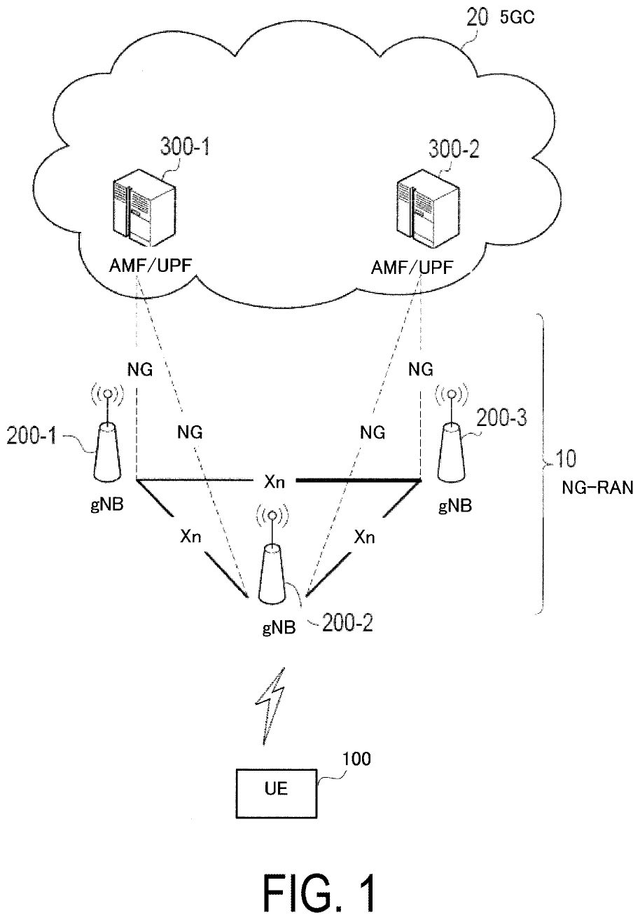

First, a configuration of a mobile communication system according to an embodiment is described. FIG. 1 is a diagram illustrating a configuration of the mobile communication system according to an embodiment. This mobile communication system complies with a 5th Generation System (5GS) of the 3GPP standard. The description below takes the 5GS as an example, but a Long Term Evolution (LTE) system may be at least partially applied to the mobile communication system. A sixth generation (6G) system may be at least partially applied to the mobile communication system.

As illustrated in FIG. 1, the mobile communication system includes a User Equipment (UE) 100, a 5G radio access network (Next Generation Radio Access Network (NG-RAN)) 10, and a 5G Core Network (5GC) 20.

The UE 100 is a mobile wireless communication apparatus. The UE 100 may be any apparatus as long as utilized by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), and/or a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency.

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

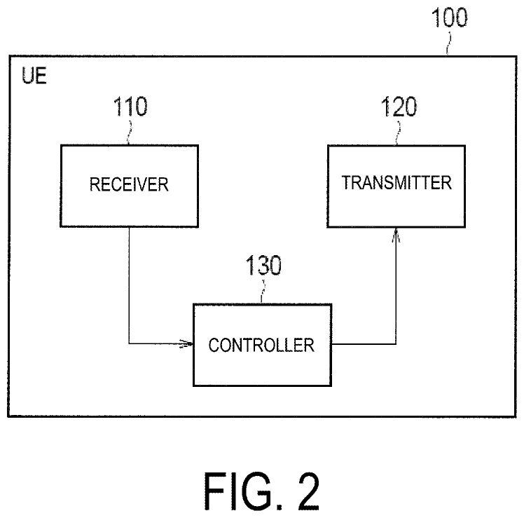

FIG. 2 is a diagram illustrating a configuration of the user equipment (UE) 100 according to an embodiment.

As illustrated in FIG. 2, the UE 100 includes a receiver 110, a transmitter 120, and a controller 130.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal output by the controller 130 (a transmission signal) into a radio signal and transmits the resulting signal through the antenna.

The controller 130 performs various types of control in the UE 100. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

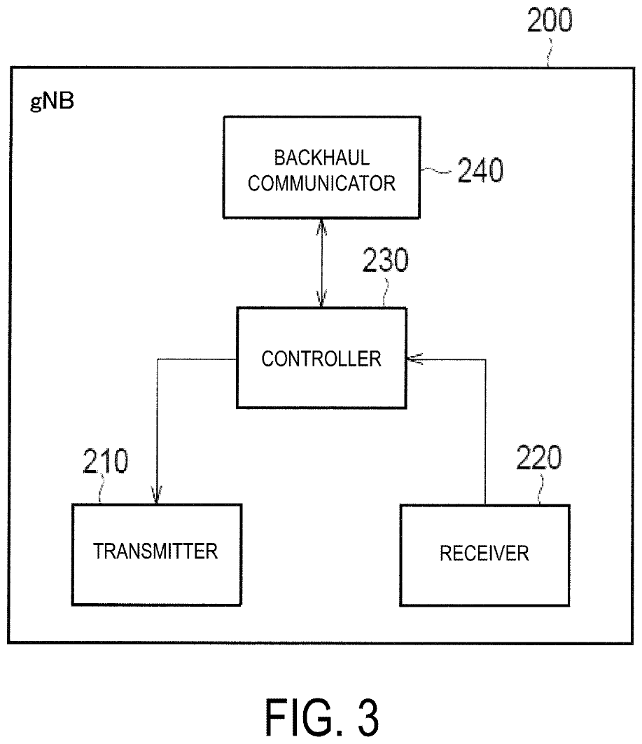

FIG. 3 is a diagram illustrating a configuration of the gNB 200 (base station) according to an embodiment.

As illustrated in FIG. 3, the gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts a baseband signal output by the controller 230 (a transmission signal) into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of controls for the gNB 200. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the inter-base station interface. The backhaul communicator 240 is connected to the AMF/UPF 300 via the interface between a base station and the core network. Note that the gNB may include a Central Unit (CU) and a Distributed Unit (DU) (i.e., functions are divided), and both units may be connected via an F1 interface.

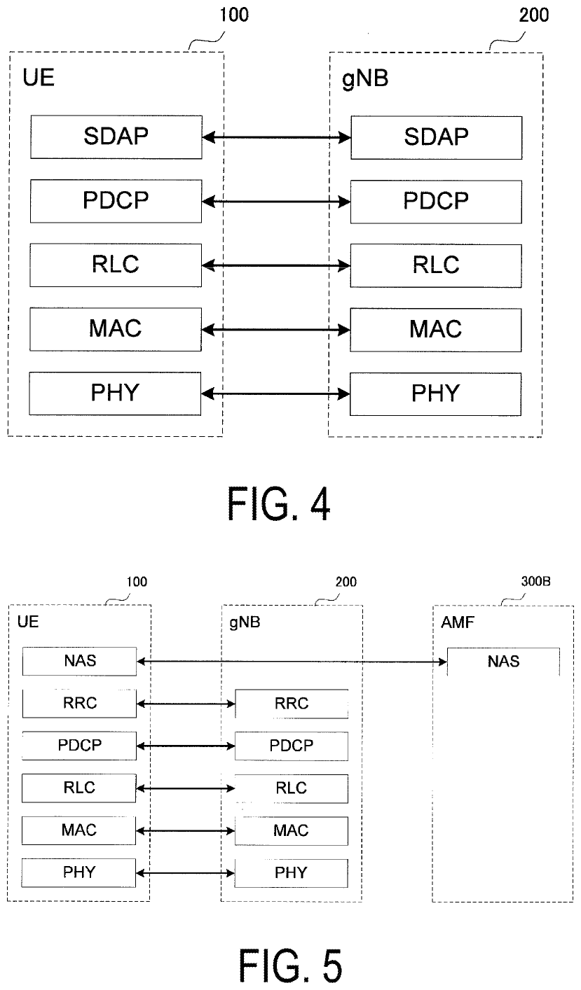

FIG. 4 is a diagram illustrating a configuration of a protocol stack of a radio interface of a user plane handling data.

As illustrated in FIG. 4, a radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel.

The MAC layer performs preferential control of data, retransmission processing using a hybrid ARQ (HARQ), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, modulation and coding schemes (MCSs)) in the uplink and the downlink, and resource blocks to be allocated to the UE 100.

The RLC layer transmits data to a receiving RLC layer by using functions of the MAC layer and the PHY layer. Data and control information are transmitted between the RLC layer of the UE 100 and the RLC layer of the gNB 200 via a logical channel.

The PDCP layer performs header compression and decompression, and encryption and decryption.

The SDAP layer performs mapping between an IP flow as the unit of QoS control by a core network and a radio bearer as the unit of QoS control by an Access Stratum (AS). Note that, when the RAN is connected to the EPC, the SDAP need not be provided.

FIG. 5 is a diagram illustrating a configuration of a protocol stack of a radio interface of a control plane handling signaling (a control signal).

As illustrated in FIG. 5, the protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, reestablishment, and release of a radio bearer. When a connection between the RRC of the UE 100 and the RRC of the gNB 200 (RRC connection) exists, the UE 100 is in an RRC connected state. When a connection between the RRC of the UE 100 and the RRC of the gNB 200 (RRC connection) does not exist, the UE 100 is in an RRC idle state. When the connection between the RRC of the UE 100 and the RRC of the gNB 200 is suspended, the UE 100 is in an RRC inactive state.

The NAS layer which is positioned higher than the RRC layer performs session management, mobility management, and the like. NAS signaling is transmitted between the NAS layer of the UE 100 and the NAS layer of an AMF 300B.

Note that the UE 100 includes an application layer other than the protocol of the radio interface.

MBS

An MBS according to an embodiment is described. The MBS is a service in which the NG-RAN 10 can provide broadcast or multicast, i.e., Point To Multipoint (PTM) data transmission to the UE 100. The MBS may be referred to as the Multimedia Broadcast and Multicast Service (MBMS). Note that use cases (service types) of the MBS include public communication, mission critical communication, V2X (Vehicle to Everything) communication, IPv4 or IPv6 multicast delivery, IPTV, group communication, and software delivery.

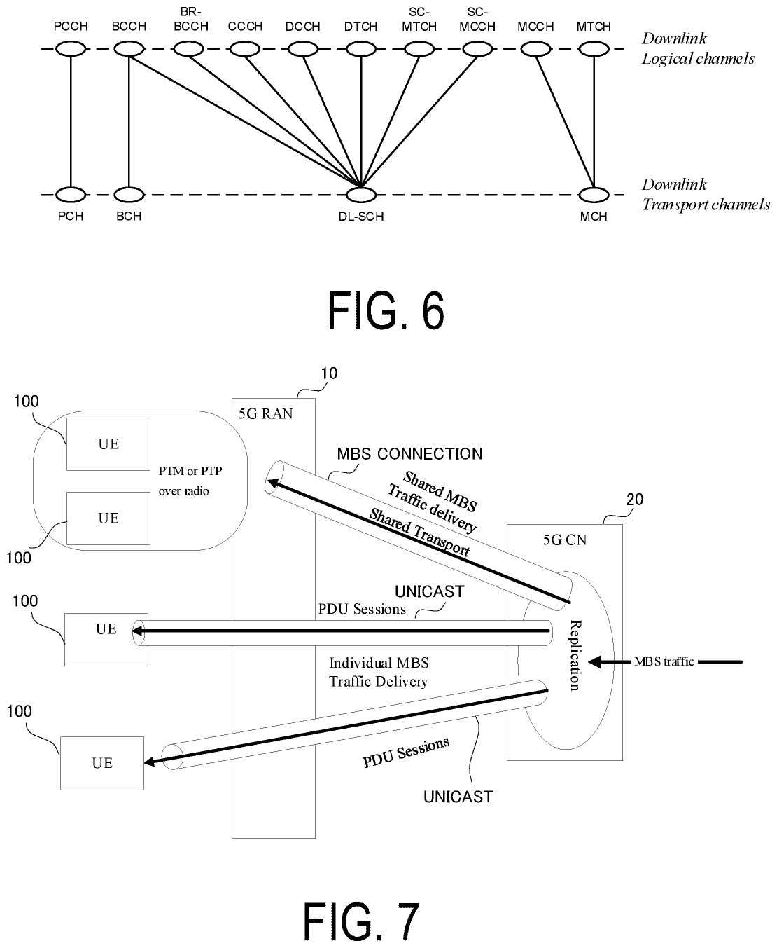

MBS Transmission in LTE includes two schemes, i.e., a Multicast Broadcast Single Frequency Network (MBSFN) transmission and Single Cell Point To Multipoint (SC-PTM) transmission. FIG. 6 is a diagram illustrating a correspondence relationship between a downlink Logical channel and a downlink Transport channel according to an embodiment.

As illustrated in FIG. 6, the logical channels used for MBSFN transmission are a Multicast Traffic Channel (MTCH) and a Multicast Control Channel (MCCH), and the transport channel used for MBSFN transmission is a Multicast Channel (MCH). The MBSFN transmission is designed primarily for multi-cell transmission, and in an MBSFN area including a plurality of cells, each cell synchronously transmits the same signal (the same data) in the same MBSFN sub frame.

The logical channels used for SC-PTM transmission are a Single Cell Multicast Traffic Channel (SC-MTCH) and a Single Cell Multicast Control Channel (SC-MCCH), and the transport channel used for SC-PTM transmission is a Downlink Shared Channel (DL-SCH). The SC-PTM transmission is primarily designed for single-cell transmission and corresponds to broadcast or multicast data transmission on a cell-by-cell basis. The physical channels used for SC-PTM transmission are a Physical Downlink Control Channel (PDCCH) and a Physical Downlink Shared Channel (PDSCH), which allow dynamic resource allocation.

Although an example will be mainly described below in which the MBS is provided using a scheme same as, and/or similar to, the SC-PTM transmission scheme, the MBS may be provided using the MBSFN transmission scheme. An example will be mainly described in which the MBS is provided using multicast. Accordingly, the MBS may be interpreted as multicast. Note that, the MBS may be provided using broadcast.

The MBS data refers to data provided by the MBS. The MBS control channel refers to the MCCH or the SC-MCCH. The MBS traffic channel refers to the MTCH or the SC-MTCH. Note that the MBS data may be transmitted in unicast. The MBS data may be referred to as MBS packets or MBS traffic.

The network can provide different MBS services for respective MBS sessions. The MBS session is identified by a Temporary Mobile Group Identity (TMGI) and/or a session identifier, and at least one of these identifiers is referred to as an MBS session identifier. Such an MBS session identifier may be referred to as an MBS service identifier or a multicast group identifier.

FIG. 7 is a diagram illustrating a delivery method of the MBS data according to an embodiment.

As illustrated in FIG. 7, the MBS data (MBS Traffic) is delivered from a single data source (application service provider) to a plurality of UEs. The 5G CN (5GC) 20, which is a core network, receives the MBS data from the application service provider and performs Replication of the MBS data to deliver the resultant.

From the perspective of the 5GC 20, two delivery methods are possible: shared MBS data delivery (Shared MBS Traffic delivery) and individual MBS data delivery (Individual MBS Traffic delivery).

In the shared MBS data delivery, a connection is established between the NG-RAN 10 that is a 5G radio access network (5G RAN) and the 5GC 20 to deliver the MBS data from the 5GC 20 to the NG-RAN 10. Such a connection (a tunnel) is hereinafter referred to as an “MBS connection”.

The MBS connection may be referred to as a Shared MBS Traffic delivery connection or a shared transport. The MBS connection terminates at the NG-RAN 10 (i.e., the gNB 200). The MBS connection may correspond to an MBS session on a one-to-one basis.

The gNB 200 selects a transmission scheme either of Point-to-Point (PTP: unicast) or Point-to-Multipoint (PTM: multicast or broadcast) at the discretion of the gNB 200 and transmits the MBS data to the UE 100 through the selected transmission scheme.

On the other hand, in the individual MBS data delivery, a unicast session is established between the NG-RAN 10 and the UE 100 to individually deliver the MB S data from the 5GC to the UE 100. Such unicast may be referred to as a PDU Session. The unicast (PDU session) terminates at the UE 100.

Split MBS Bearer

A split MBS bearer according to an embodiment is described.

The gNB 200 may establish an MBS bearer split into a PTP communication path and a PTM communication path (hereinafter referred to as a “split MBS bearer” as appropriate) for the UE 100. This allows the gNB 200 to dynamically switch the transmission of the MBS data to the UE 100 between the PTP (PTP communication path) and the PTM (PTM communication path). The gNB 200 may perform duplication transmission of the same MBS data using both the PTP (PTP communication path) and the PTM (PTM communication path) to enhance the reliability.

A predetermined layer terminating the split is the MAC layer (HARQ), the RLC layer, the PDCP layer, or the SDAP layer. Although an example in which the predetermined layer terminating the split is the PDCP layer will be mainly described below, the predetermined layer may be the MAC layer (HARQ), the RLC layer, or the SDAP layer.

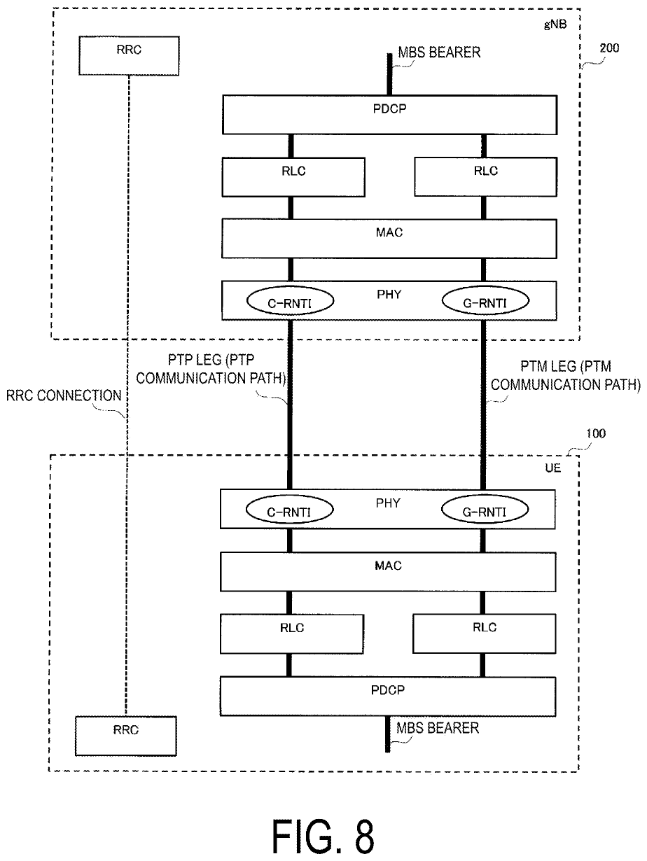

FIG. 8 is a diagram illustrating the split MBS bearer according to an embodiment. Hereinafter, the PTP communication path is referred to as a PTP leg, and the PTM communication path is referred to as a PTM leg. A functional unit corresponding to each layer is referred to as an entity.

As illustrated in FIG. 8, each of the PDCP entity of the gNB 200 and the PDCP entity of the UE 100 splits an MBS bearer, which is a bearer (data radio bearer) used for the MBS, into a PTP leg and a PTM leg. Note that the PDCP entity is provided for each bearer.

Each of the gNB 200 and the UE 100 includes two RLC entities provided for the respective legs, one MAC entity, and one PHY entity. The PHY entity may be provided per leg. Note that, in a Dual Connectivity in which the UE 100 communicates with two gNBs 200, the UE 100 may include two MAC entities.

The PHY entity transmits and receives data of the PTP leg by using a cell RNTI (Cell Radio Network Temporary Identifier (C-RNTI)) that is allocated to the UE 100 on a one-to-one basis. The PHY entity transmits and receives data of the PTM leg by using a group RNTI (Group Radio Network Temporary Identifier (G-RNTI)) allocated to the MBS session on a one-to-one basis. The C-RNTI is different for each UE 100, but the G-RNTI is an RNTI common to a plurality of UEs 100 receiving one MBS session.

In order to perform PTM transmission of the MBS data (multicast or broadcast) from the gNB 200 to the UE 100 using a PTM leg, a split MBS bearer needs to be established for the UE 100 from the gNB 200 and the PTM leg needs to be activated. In other words, even if a split MBS bearer is established for the UE 100, when a PTM leg is in a deactivation state, the gNB 200 cannot perform the PTM transmission of the MBS data using the PTM leg.

In order that the gNB 200 and the UE 100 perform PTP transmission of the MBS data (unicast) using a PTP leg, a split MBS bearer needs to be established for the UE 100 from the gNB 200 and the PTP leg needs to be activated. In other words, even if a split MBS bearer is established for the UE 100, when a PTP leg is in a deactivation state, the gNB 200 cannot perform the PTP transmission of the MBS data using the PTP leg.

When the PTM leg is in an activated state, the UE 100 monitors a Physical Downlink Control Channel (PDCCH) to which a G-RNTI associated with the MBS session is applied (i.e., performs blind decoding of the PDCCH using the G-RNTI). The UE 100 may monitor the PDCCH only at a scheduling occasion of the MBS session.

When the PTM leg is in a deactivated state, the UE 100 does not monitor a PDCCH to which a G-RNTI associated with the MBS session is applied (i.e., does not perform blind decoding of the PDCCH using the G-RNTI).

When the PTP leg is in an activated state, the UE 100 monitors a PDCCH to which a C-RNTI is applied. When Discontinuous Reception (DRX) in the PTP leg is configured, the UE 100 monitors a PDCCH for a configured OnDuration period. When a cell (frequency) associated with the MBS session is specified, the UE 100 may monitor a PDCCH for the cell even when the cell is deactivated.

When the PTP leg is in a deactivated state, the UE 100 may monitor a PDCCH to which a C-RNTI is applied in preparation for normal unicast downlink transmission of other than the MBS data. Note that, when a cell (frequency) associated with the MBS session is specified, the UE 100 need not monitor the PDCCH for the MBS session.

Note that the above-described split MBS bearer is assumed to be established by use of an RRC message (for example, an RRC Reconfiguration message) transmitted by the RRC entity of the gNB 200 to the RRC entity of the UE 100.

Activation and Deactivation of Leg

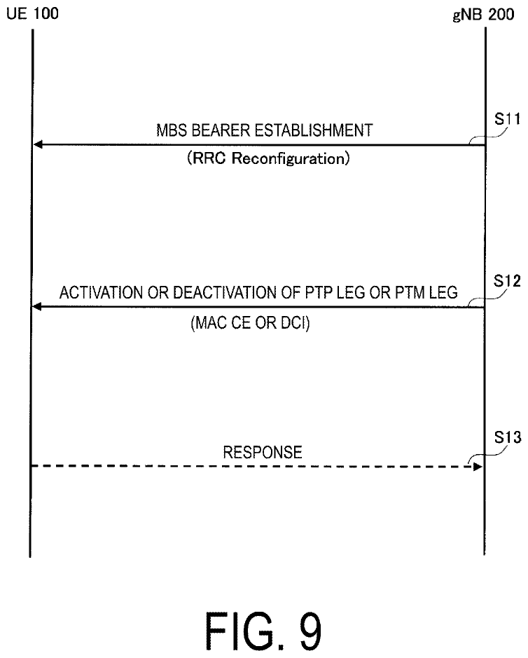

The activation and deactivation of a leg according to an embodiment is described. FIG. 9 is a diagram illustrating an operation example related to the activation and deactivation of a leg according to an embodiment.

As illustrated in FIG. 9, in step S11 the RRC entity of the gNB 200 transmits to the UE 100 an RRC message including the establishment of the split MBS bearer (split bearer) illustrated in FIG. 8. The RRC message may be an RRC Reconfiguration message, for example. The RRC entity of the UE 100 establishes a split MBS bearer based on the configuration included in the RRC message received from the gNB 200. Although an example in which one split MBS bearer is established by the UE 100 is mainly described below, the UE 100 may establish a plurality of split MBS bearers depending on the configuration from the gNB 200.

The gNB 200, when establishing a bearer by use of the RRC message (RRC Reconfiguration message), may indicate an initial state of each leg (that is, activation or deactivation of each leg) to the UE 100 by use of the same message. The RRC entity of the gNB 200, when transmitting the RRC message including the bearer establishment of the split MBS bearer to the UE 100, includes an indication to activate or deactivate each leg together with the bearer establishment in the RRC message.

Such an RRC message may include an identifier of a leg (a PTP leg or a PTM leg) to be indicated and/or an identifier indicating either of activation or deactivation. The RRC message may include an identifier (for example, a TMGI, a G-RNTI, a session identifier, a QoS flow identifier, or a bearer identifier) associated with the MBS session (split MBS bearer) to be indicated.

In step S12, the gNB 200 transmits to the UE 100 an indication to individually activate or deactivate the PTP leg and the PTM leg.

Here, the MAC entity of the gNB 200 may transmit a MAC control element (MAC CE) including the indication to the UE 100. The MAC entity of the UE 100 receives the MAC CE from gNB 200. The PHY entity of the gNB 200 may transmit downlink control information (DCI) including the indication to the UE 100. The PHY entity of the UE 100 receives the DCI from the gNB 200.

Such a MAC CE or DCI may include an identifier of a leg (a PTP leg or a PTM leg) to be indicated and/or an identifier indicating either of activation or deactivation. The MAC CE or the DCI may include an identifier (for example, a TMGI, a G-RNTI, a session identifier, a QoS flow identifier, or a bearer identifier) associated with the MBS session (split MBS bearer) to be indicated.

Indicating the activation and deactivation of each leg by use of the MAC CE or the DCI allows dynamic control compared with a case by use of the RRC message.

The UE 100, in response to receiving the indication to activate the PTP leg, starts reception processing of the data using the C-RNTI. The UE 100, in response to receiving the indication to activate the PTM leg, starts reception processing of the MBS data using the G-RNTI. On the other hand, the UE 100, in response to receiving the indication to deactivate the PTP leg, ends the reception processing of the data using the C-RNTI. The UE 100, in response to receiving the indication to deactivate the PTM leg, ends the reception processing of the MBS data using the G-RNTI.

In step S12, the gNB 200 may transmit an indication to activate or deactivate the PTP leg to the UE 100 via the PTM leg in the activated state (PTM transmission). This can collectively activate or deactivate the PTP legs of a plurality of UEs 100 via the PTM.

The gNB 200 may transmit an indication to deactivate the PTM leg to the UE 100 via the PTM leg in the activated state (PTM transmission). This can collectively deactivate the PTM legs of a plurality of UEs 100 via the PTM.

In step S12, the gNB 200 may transmit an indication to activate or deactivate the PTM leg to the UE 100 via the PTP leg in the activated state (PTP transmission). This can individually activate or deactivate the PTM leg for each UE 100.

The gNB 200 may transmit an indication to deactivate the PTP leg to the UE 100 via the PTP leg in the activated state (PTP transmission). This can individually deactivate the PTP leg for each UE 100.

In step S13, the UE 100, in response to receiving the indication to activate the PTP leg and/or the PTM leg from the gNB 200 in step S12, may transmit to the gNB 200 a response to the received indication. This response may be transmitted from the MAC entity of the UE 100 to the gNB 200 via the PTP leg, for example. The UE 100, after transmitting the response, may start a data reception operation on the activated leg.

The gNB 200, in response to receiving the response from the UE 100, transmits data via the activated leg. In other words, the gNB 200, after receiving the response, starts a data transmission operation on the leg.

Note that the UE 100, in response to receiving the indication to deactivate the PTP leg and/or the PTM leg from the gNB 200 in step S12, may transmit to the gNB 200 a response to the received indication.

When both the PTP leg and the PTM leg are activated, the PDCP entity of the UE 100 may perform a duplicate packet discarding process on two identical MBS packets transmitted through the Duplication transmission.

When the PTP leg is deactivated, the RRC entity of the UE 100 may transmit to the gNB 200 a message (RAI: Release Assistance Information/preference) for prompting the gNB 200 to release the RRC connection. The UE 100 may be permitted to transmit the RAI even when dynamic switching between the PTP leg and the PTM leg is being configured.

Switching between PTP Transmission and PTM Transmission Switching between PTP transmission and PTM transmission according to an embodiment is described.

Assuming the use of the split MBS bearer, the PTP transmission may be a scheme of transmitting the MBS data from the gNB 200 to the UE 100 by using the PTP leg (PTP communication path). The PTM transmission may be a scheme of transmitting the MBS data from the gNB 200 to the UE 100 by using the PTM leg (PTM communication path). The operation of switching between the PTP transmission and the PTM transmission may be an operation of ending an MBS data transmission through one transmission scheme of the PTP transmission and the PTM transmission, while simultaneously starting an MBS data transmission through the other transmission scheme. In such a switching operation, some of the MBS data (MBS packets) transmitted from the gNB 200 to the UE 100 may drop to cause a gap.

There is also a problem of when the gNB 200 is to stop the PTP transmission in switching from the PTP transmission to the PTM transmission. Conversely, in switching from the PTM transmission to the PTP transmission, there is a problem of from which packet the gNB 200 is to start the PTP transmission. In other words, the problem is that the PTP transmission is difficult to be controlled appropriately in switching between the PTP transmission and the PTM transmission.

In an embodiment, the UE 100 receives MBS data transmitted from the gNB 200 through a transmission scheme either of the PTP transmission or the PTM transmission. Thereafter, in response to switching of the transmission scheme between the PTP transmission and the PTM transmission, the UE 100 transmits to the gNB 200 a message including information indicating a sequence number (SN) (hereinafter referred to as an “SN notification message”) of a received packet related to the switching. The SN may be a PDCP SN assigned in units of PDCP packets. The SN may be a COUNT value for identifying a PDCP packet. The COUNT value includes a Hyper Frame Number (HFN) and a PDCP SN. The SN may be an RLC SN assigned in units of RLC packets. In the following, assume mainly a case that the SN is a PDCP SN. Thus, a packet refers to a PDCP packet.

As described above, the UE 100 transmits to the gNB 200 the SN notification message including the SN information of the received packet regarding the switching between the PTP transmission and the PTM transmission, so that the gNB 200 can grasp a reception state of the MBS packet in the UE 100. This allows the PTP transmission to be controlled appropriately in switching between the PTP transmission and the PTM transmission. For example, the gNB 200 controls the PTP transmission to fill a gap in SN between the PTP transmission and the PTM transmission. The gap in SN refers to a difference between an SN of a PTP transmission packet and an SN of a PTM transmission packet.

In an embodiment, in the switching between the PTP transmission and the PTM transmission, the UE 100 may transmit the SN notification message in response to detecting a gap in SN between the PTP transmission and the PTM transmission. When the SN of the PTP transmission packet and the SN of the PTM transmission packet are discontinuous, the UE 100 may determine that a gap in SN is caused. When the UE 100 dose not detect a gap in SN between the PTP transmission and the PTM transmission in the switching between the PTP transmission and the PTM transmission, the US 100 need not transmit the SN notification message to the gNB 200.

(1) Switching from PTP transmission to PTM transmission Switching from the PTP transmission to the PTM transmission according to an embodiment is described.

In switching from the PTP transmission to the PTM transmission, the UE 100 transmits to the gNB 200 an SN notification message including information indicating an SN of a packet received first through the PTM transmission and/or information indicating an SN of a packet desired to be received last through the PTP transmission. Based on such an SN notification message, the gNB 200 transmits one or more packets corresponding to a gap in SN between the PTP transmission and the PTM transmission (i.e., MBS packets not received by the UE 100) to the UE 100 through the PTP transmission. As a result, the gap caused upon switching from the PTP transmission to the PTM transmission can be compensated by the PTP transmission. The gNB 200, after completing such PTP transmission of unreceived MBS packets, may stop the PTP transmission (e.g., deactivate the PTP leg). Alternatively, the UE 100, when receiving the unreceived MBS packets through the PTP transmission, may determine that the PTP transmission is completed and deactivate the PTP leg. In this case, the gNB 200 does not need to explicitly deactivate the PTP leg after completing the PTP transmission. Even if the UE 100 does not receive the indication to deactivate the PTP leg from the gNB 200, the UE 100 autonomously deactivates the PTP leg when receiving the unreceived MBS packets through the PTP transmission. The UE 100 may be capable of autonomously deactivating the PTP leg when the UE 100 is configured in advance by the gNB 200 with a permission to autonomously deactivate the PTP leg.

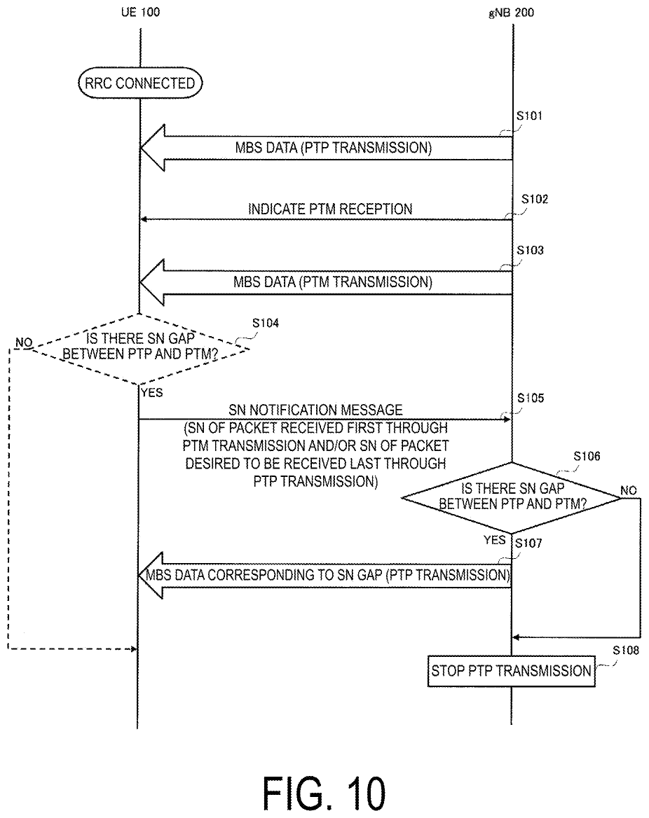

FIG. 10 is a diagram illustrating an operation example of switching from the PTP transmission to the PTM transmission according to an embodiment. In the operation example, assume that the UE 100 is in an RRC connected state and is established with the PTP leg. Note that the UE 100 may be established with the PTP bearer without assuming the split MBS bearer. That is, the UE 100 is sufficient to be established with the PTP communication path.

As illustrated in FIG. 10, in step S101, the gNB 200 transmits the MBS data to the UE 100 via the PTP communication path through the PTP transmission. The MBS data includes a plurality of packets assigned continuous SNs. The UE 100 receives the MBS data via the PTP communication path.

In step S102, the gNB 200 provides an indication for the UE 100 to receive the MBS data through the PTM transmission. Specifically, the gNB 200 transmits, to the UE 100, an indication to switch from the PTP transmission to the PTM transmission. The switching indication is transmitted from the gNB 200 to the UE 100 via the PTP communication path. The UE 100 receives the switching indication from the gNB 200. Here, the indication to switch from the PTP transmission to the PTM transmission may be an RRC Reconfiguration message for establishing a PTM bearer and/or an indication to activate the PTM leg (e.g., MAC CE or DCI). The indication to switch from the PTP transmission to the PTM transmission may be an indication to deactivate the PTP leg.

In step S103, the gNB 200 transmits the MBS data to the UE 100 via the PTM communication path (PTM leg or PTM bearer) through the PTM transmission. Note that the PTM transmission may already be used to transmit the MBS data to another UE. That is, the UE 100 may start reception with a delay through the PTM transmission through which the MBS data transmission has already started. The UE 100 receives the MBS data via the PTM communication path. Here, the UE 100 specifies an SN of a packet received first through the PTM transmission by acquiring the SN included in the packet received first via the PTM communication path.

Based on the SN of the packet received first through the PTM transmission, the UE 100 may determine an SN of a packet that the UE 100 desires to receive last through the PTP transmission. For example, when the SN of the packet received first through the PTM transmission is “#30”, the SN of the packet desired to be received last through the PTP transmission is “#29” in order not to cause a gap.

In step S104, the UE 100 may determine whether a gap in SN between the PTP transmission and the PTM transmission is present. When the SN of the packet received last through the PTP transmission and the SN of the packet received first through the PTM transmission are discontinuous, the UE 100 detects the gap in SN. For example, when the SN of the packet received last through the PTP transmission is “#10” and the SN of the packet received first through the PTM transmission is “#30”, the SNs are discontinuous, and thus the UE 100 detects the gap in SN.

In step S105, the UE 100 transmits, to the gNB 200 via the PTP communication path, an SN notification message including information indicating the SN of the packet received first through the PTM transmission and/or information indicating the SN of the packet desired to be received last through the PTP transmission. The gNB 200 receives the SN notification message from the UE 100 via the PTP communication path. Note that the SN notification message may be transmitted only when permitted by the gNB 200. For example, whether to transmit the SN notification message is configured for the UE 100 in advance by the gNB 200 using RRC Reconfiguration.

For example, the SN notification message may include the SN of the packet received first through the PTM transmission. The SN notification message may include information indicating each SN from the SN of the packet received last through the PTP transmission to the SN of the packet received first through the PTM transmission.

The SN notification message may include the SN of the packet desired to be received last through the PTP transmission. The SN notification message may include information indicating each SN from the SN of the packet received last through the PTP transmission to the SN of the packet desired to be received last through the PTP transmission. The SN notification message may include SNs of a plurality of packets corresponding to the gap. For example, when the SN of the packet already received through the PTP transmission is #20 and the SN of the packet received first through the PTM transmission is #30, the UE 100 includes the SNs of #21 to #29 in the SN notification message.

The UE 100 may transmit the SN notification message to the gNB 200 if “YES” in step S104 and need not transmit the SN notification message to the gNB 200 if “NO” in step S104. When “NO” in step S104, the UE 100 may transmit to the gNB 200 a PTM reception success notification indicating that a packet is received through the PTM transmission. Note that the UE 100, when transmitting the SN notification message to the gNB 200, need not transmit the PTM reception success notification to the gNB 200. The PTM reception success notification may be a PTM reception start notification.

A transmission trigger for the SN notification message may be any one of 1) when the first one packet is received through the PTM transmission, 2) when N (N≥2) continuous packets are received through the PTM transmission, and 3) when an indication to receive the MBS data through the PTM transmission (for example, the indication in step S102) is received from the gNB 200. When the above transmission trigger of 2) is used, the number of packets to be counted (i.e., the value of “N”) may be configured in advance by the gNB 200 for the UE 100.

The SN notification message may be any one of 1) a PDCP Control Protocol Data Unit (PDU), 2) an RLC Control PDU, and 3) an RRC message. The PDCP Control PDU used as the SN notification message may be a Status PDU or may be a new Control PDU. The RLC Control PDU used as the SN notification message may be a Status PDU or may be a new Control PDU.

In step S106, based on the SN notification message received from the UE 100, the gNB 200 determines whether a gap in SN between the PTP transmission and the PTM transmission is present. When the gNB 200 grasps an SN of a packet completed to be transmitted through the PTP transmission, the gNB 200 can compare the SN of the packet completed to be transmitted through the PTP transmission with the SN indicated in the SN notification message to determine whether a gap in SN is present.

As an example, assume that the SN of the packet completed to be transmitted through the PTP transmission is “#10” and the SN of the packet received first through the PTM transmission is “#30”. In this case, the gNB 200 compares the SN “#30” included in the SN notification message with the SN “#10” and detects a gap in SN because the SNs are discontinuous. The gNB 200 may determine to transmit the packets of the SN “#11” to “#29” to the UE 100 through the PTP transmission.

As another example, assume that the SN of the packet completed to be transmitted through the PTP transmission is “#10” and the SN of the packet that the UE 100 desires to receive last through the PTP transmission is “#29”. In this case, the gNB 200 compares the SN “#29” included in the SN notification message with the SN “#10” and detects a gap in SN because the SNs are discontinuous. The gNB 200 may determine to transmit the packets of the SN “#11” to “#29” to the UE 100 through the PTP transmission.

If “YES” in step S106, the gNB 200, in step S107, transmits one or more packets corresponding to the detected gap (i.e., the MBS packets not received by the UE 100) to the UE 100 through PTP transmission. On the other hand, if “NO” in step S106, the gNB 200 need not perform step S107.

When the UE 100 receives such packets transmitted through the PTP transmission and the gap is filled, the UE 100 may transmit a reception success notification of the PTM transmission to the gNB 200. As described above, the UE 100 may autonomously deactivate the PTP leg.

In step S108, the gNB 200 stops the PTP transmission to the UE 100. For a split MBS bearer, the gNB 200 may transmit an indication to deactivate the PTP leg to the UE 100. Not for a split MBS bearer, the gNB 200 may transmit an indication to release the PTP bearer to the UE 100.

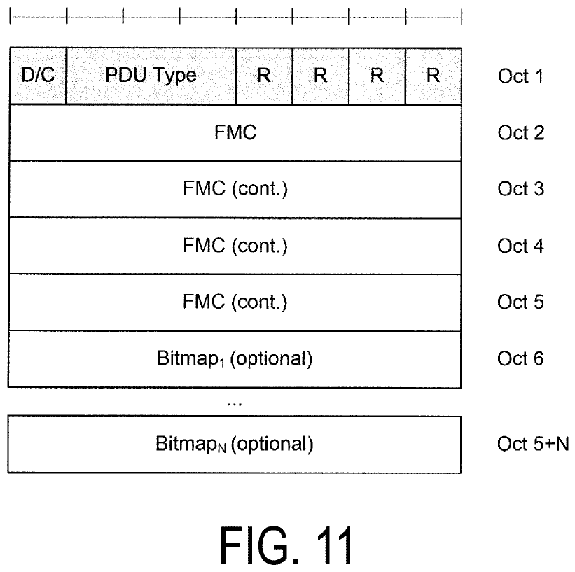

An example of the SN notification message is described. Here, a case that the SN notification message is configured by diverting the Status PDU (PDCP status report) of the PDCP is described. FIG. 11 is a diagram illustrating a configuration example of an SN notification message according to an embodiment.

As illustrated in FIG. 11, the PDCP status report includes, as main components, a “D/C” field having a 1-bit length, a “PDU Type” field having a 3-bit length, an “First Missing COUNT (FMC)” field having a 32-bit length, and a “Bitmap” field having a variable bit length.

The “D/C” field is a field indicating whether this PDCP PDU is a PDCP Data PDU or a PDCP Control PDU. The PDCP status report corresponds to a PDCP Control PDU.

The “PDU Type” field is a field indicating whether this PDCP Control PDU is a “PDCP status report”, “Interspersed ROHC feedback”, or “EHC feedback”.

The “First Missing COUNT (FMC)” field is a field indicating a count value (COUNT) of a first missing PDCP SDU in a reordering window. Note that the count value (COUNT) includes a Hyper Frame Number (HFN) and a PDCP SN.

The “Bitmap” field is a field indicating a missing PDCP SDU and a PDCP SDU successfully received at a receiving PDCP entity. Specifically, the “Bitmap” field indicates a reception status of the PDCP SDU from the FMC onwards as “0” (missing) or “1” (successfully received).

For the switching from the PTP transmission to the PTM transmission, the gap between the SN of the packet received last through the PTP transmission and the SN of the packet received first through the PTM transmission may be reported as the SNs of the missing packets (NACK). The FMC may also indicate a packet following the packet received through the PTP transmission. The Bitmap may be configured such that the upper limit of the Bitmap is a packet before the first received packet through the PTM transmission.

(2) Switching from PTM transmission to PTP transmission Switching from the PTM transmission to the PTP transmission according to an embodiment is described.

In switching from the PTM transmission to the PTP transmission, the UE 100 transmits to the gNB 200 an SN notification message including information indicating an SN of a packet received last through the PTM transmission and/or information indicating an SN of a packet desired to be received first through the PTP transmission. Then, based on such an SN notification message, the gNB 200 determines an SN of a transmission start packet in the PTP transmission. As a result, the PTP transmission can be controlled so that no gap is caused upon switching from the PTM transmission to the PTP transmission.

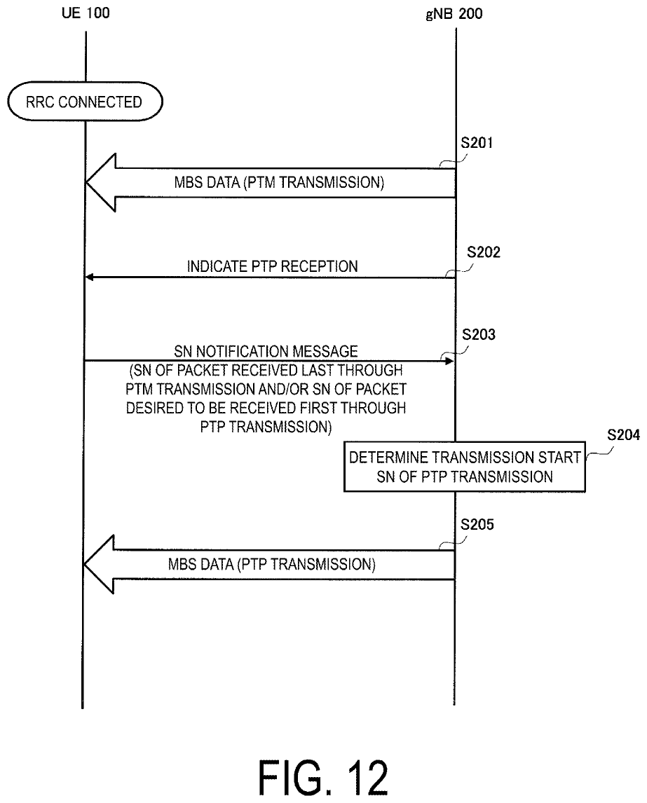

FIG. 12 is a diagram illustrating an operation example of switching from the PTM transmission to the PTP transmission according to an embodiment. In the operation example, assume that the UE 100 is in an RRC connected state and is established with the PTM leg. Note that the UE 100 may be established with the PTM bearer without assuming the split MBS bearer. That is, the UE 100 is sufficient to be established with the PTM communication path.

As illustrated in FIG. 12, in step S201, the gNB 200 transmits the MBS data to the UE 100 via the PTM communication path through the PTM transmission. The MBS data includes a plurality of packets assigned continuous SNs. The UE 100 receives the MBS data via the PTM communication path.

In step S202, the gNB 200 provides an indication for the UE 100 to receive the MBS data through the PTP transmission. Specifically, the gNB 200 transmits, to the UE 100, an indication to switch from the PTM transmission to the PTP transmission. The switching indication is transmitted from the gNB 200 to the UE 100 via the PTP communication path or the PTM communication path. The UE 100 receives the switching indication from the gNB 200. Here, the indication to switch from the PTM transmission to the PTP transmission may be an RRC Reconfiguration message for establishing a PTP bearer and/or an indication to activate the PTP leg (e.g., MAC CE or DCI). The indication in step S202 may be an indication to deactivate the PTM leg. In this case, the UE 100 may stop the reception processing of the PTM leg of the split bearer or release the PTM bearer. The UE 100 may temporarily continue the PTM leg reception processing or the PTM bearer in order to enhance service continuity (that is, the UE 100 stops the PTM leg reception processing or releases the PTM bearer after a certain time period elapses).

In step S203, the UE 100 transmits, to the gNB 200 via the PTP communication path, an SN notification message including information indicating an SN of a packet received last through the PTM transmission and/or information indicating an SN of a packet desired to be received first through the PTP transmission. The gNB 200 receives the SN notification message from the UE 100 via the PTP communication path.

Here, based on the SN of the packet received last through the PTM transmission, the UE 100 may determine an SN of a packet that the UE 100 desires to receive first through the PTP transmission. For example, when the SN of the packet received last through the PTM transmission is “#15”, the SN of the packet desired to be received first through the PTP transmission is “#16” in order not to cause a gap.

A transmission trigger for the SN notification message may be any one of 1) when the last one packet is received through the PTM transmission and 2) when an indication to receive the MBS data through the PTP transmission (for example, the indication in step S202) is received from the gNB 200.

The SN notification message may be any one of 1) a PDCP Control Protocol Data Unit (PDU), 2) an RLC Control PDU, and 3) an RRC message. The PDCP Control PDU used as the SN notification message may be a Status PDU and/or a new Control PDU. The RLC Control PDU used as the SN notification message may be a Status PDU and/or a new Control PDU.

In step S204, based on the SN notification message from the UE 100, the gNB 200 determines an SN of a transmission start packet in the PTP transmission. As an example, when the SN notification message indicates that the SN of the packet received last through the PTM transmission is “#10”, the gNB 200 may determine to start the PTP transmission to the UE 100 from the packet of the SN “#11”. As another example, when the SN notification message indicates that the SN of the packet desired to be received first through the PTP transmission is “#11”, the gNB 200 may determine to start the PTP transmission to the UE 100 from the packet of the SN “#11”.

In step S205, the gNB 200 performs the PTP transmission to the UE 100 from the packet of the SN determined in step S204 (i.e., transmits the MBS data to the UE 100 via the PTP communication path). For a split MBS bearer, the gNB 200 may transmit an indication to deactivate the PTM leg to the UE 100. Not for a split MBS bearer, the gNB 200 may transmit an indication to release the PTM bearer to the UE 100.

PTM Monitoring Operation

A PTM monitoring operation according to an embodiment is described. The UE 100 established with the PTM communication path (PTM leg or PTM bearer) performs the PTM monitoring operation. As described above, the PTM monitoring operation may be an operation of monitoring a PDCCH to which a G-RNTI associated with an MBS session is applied when the PTM leg is in an activated state.

However, since the PTM communication path is mainly used for multicast directed to a plurality of UEs 100, individual adaptive control (for example, adaptive modulation and coding) is difficult to perform for each UE 100 according to a radio state. Therefore, the UE 100 in the poor radio state is considered to be not able to successfully receive the MBS data transmitted through the PTM transmission. Such a UE 100, when performing the PTM monitoring operation, wastefully consumes electrical power, which is inefficient. Therefore, the UE 100 preferably stops the PTM monitoring operation when the radio state is worse.

In an embodiment, the UE 100 performs the PTM monitoring operation to attempt to receive the MBS data transmitted from the gNB 200 via the PTM communication path. In the following, assume that a split MBS bearer is established for the UE 100 and the PTM leg is in an activated state. Such a UE 100 performs the PTM monitoring operation. The UE 100 stops the PTM monitoring operation in response to detecting deterioration in a measurement value indicating the communication quality of the PTM leg.

In this manner, the UE 100 stopping the PTM monitoring operation in response to detecting deterioration in the measurement value indicating the communication quality of the PTM leg can suppress the UE 100 from wastefully consuming electrical power.

Note that the measurement value indicating the communication quality of the PTM leg may be common to or different from a measurement value indicating the communication quality of the PTP leg. For example, if the PTM leg and the PTP leg for the UE 100 are established in the same cell, a measurement value common to the PTM leg and the PTP leg may be used. If the PTM leg and the PTP leg for the UE 100 are established in different cells, a measurement value dedicated to the PTM leg may be used.

The measurement value indicating the communication quality may be at least one selected from the group consisting of RSRP, RSRQ, and SINR of the radio signal from the gNB 200. The measurement value indicating the communication quality may be a reception error rate of the MBS data and/or the number of times reception errors are continuously detected.

The UE 100, when stopping the PTM monitoring operation, may transmit a notification indicating the stop of the PTM monitoring operation to the gNB 200. This allows the gNB 200 to grasp that the UE 100 cannot receive the MBS data transmitted through the PTM transmission. For such a UE 100, the gNB 200 may transmit the MBS data through, for example, the PTP transmission. In the PTP transmission, the individual adaptive control according to the radio state can be performed so that even the UE 100 in the poor radio state can receive the MBS data.

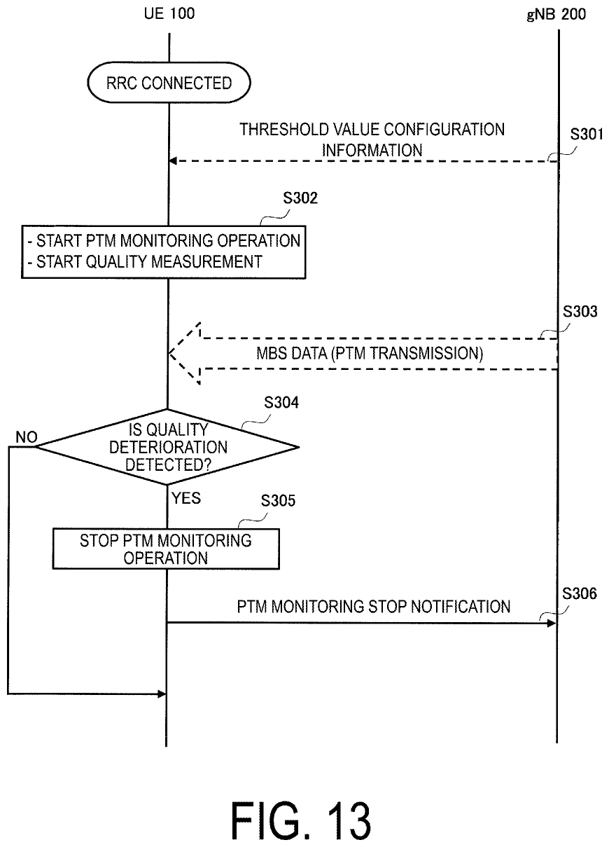

FIG. 13 is a diagram illustrating an operation example related to the PTM monitoring operation according to an embodiment. In the operation example, assume that the UE 100 is in an RRC connected state and is established with a split MBS bearer.

As illustrated in FIG. 13, in step S301, the gNB 200 may transmit configuration information including a threshold value of the PTM radio state to the UE 100 via the PTM leg or the PTP leg. The gNB 200 may configure the threshold value of the PTM radio state for the UE 100 in an RRC Reconfiguration message or an SIB. The UE 100 configures the threshold value specified by the gNB 200.

In step S302, the UE 100 starts a PTM monitoring operation and a PTM leg communication quality measuring operation.

In step S303, the gNB 200 may transmit the MBS data to the UE 100 via the PTM leg through the PTM transmission. The UE 100 may receive PTM data by the PTM monitoring operation.

In Step S304, the UE 100 compares the measurement value indicating the communication quality of the PTM leg with the threshold value and determines whether the communication quality of the PTM leg deteriorates below the threshold value. The fact that the communication quality deteriorates below the threshold value may be a fact that the RSRP, the RSRQ, or the SINR is below the threshold value, or may be a fact that the reception error rate or the number of times reception errors are continuously detected is above the threshold value.

When the communication quality of the PTM leg deteriorates below the threshold value (step S304: YES), the UE 100, in step S305, stops the monitoring operation of the PTM leg. In this case, in step S306, the UE 100 may transmit a notification indicating the stop of the monitoring operation of the PTM leg to the gNB 200 via the PTP leg. The UE 100 may also transmit the SN notification message described above to the gNB 200.

The UE 100, after stopping the monitoring operation of the PTM leg, may continue to measure the RSRP, the RSRQ, or the SINR. When the RSRP, the RSRQ, or the SINR is improved, the UE 100 may resume the monitoring operation of the PTM leg. The UE 100 may transmit a notification indicating that the monitoring operation of the PTM leg is resumed to the gNB 200 via the PTP leg. The UE 100 may also transmit the SN notification message described above to the gNB 200.

### OTHER EMBODIMENTS

In the embodiment described above, an example is mainly described in which the PTP communication path is configured using the PTP leg and the PTM communication path is configured using the PTM leg by using the split MBS bearer. However, the PTP communication path may be configured using a first radio bearer for PTP and the PTM communication path may be configured using a second radio bearer for PTM, by using two radio bearers (two data radio bearers). The PTP transmission may be a scheme of transmitting the MBS data from the gNB 200 to the UE 100 by using, as the PTP communication path, a PTP bearer that is a first data radio bearer for PTP. The PTM transmission may be a scheme of transmitting the MBS data from the gNB 200 to the UE 100 by using, as the PTM communication path, a PTM bearer that is a second data radio bearer for PTM. Under such an assumption, the SN notification message describe above may include information indicating the MBS service (or session). For example, the information may be a TMGI, a Session ID, or a G-RNTI. As a result, even when the bearer is changed, the gNB 200 can easily grasp which MBS bearer the SN notification message corresponds to.

The operation flows described above can be separately and independently implemented, and also be implemented in combination of two or more of the operation flows. For example, some of the steps in one operation flow may be added to another operation flow. Some of the steps in one operation flow may be replaced with some of the steps of another operation flow.

In the embodiment described above, an example in which the base station is an NR base station (i.e., a gNB) is described; however, the base station may be an LTE base station (i.e., an eNB). The base station may be a relay node such as an Integrated Access and Backhaul (IAB) node. The base station may be a Distributed Unit (DU) of the IAB node.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing the processes to be performed by the UE 100 or the gNB 200 may be integrated, and at least part of the UE 100 or the gNB 200 may be configured as a semiconductor integrated circuit (a chipset or an SoC).

Embodiments have been described above in detail with reference to the drawings, but specific configurations are not limited to those described above, and various design variation can be made without departing from the gist of the present disclosure.

Supplementary Note 1

MRB Configuration (Preparation)

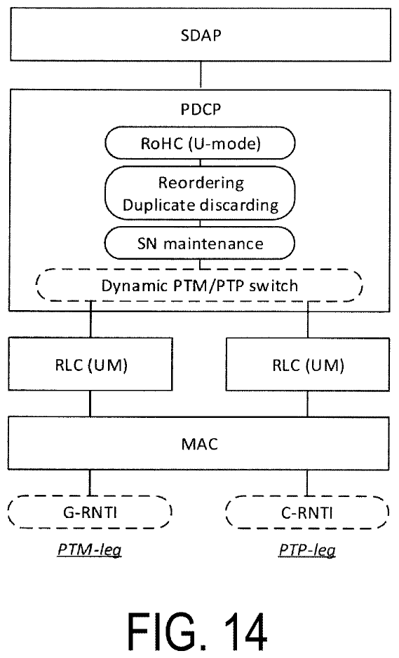

The architecture of PDCP anchored PTM/PTP switch can be interpreted as illustrated in FIG. 14, based on current agreement.

In general, RRC reconfiguration may be considered to be used to provide information for receiving a multicast session and bearer establishment including two logical channels (a PTM leg and a PTP leg).

Therefore, the RAN2 needs to first confirm that the configuration of associating two logical channels with one multicast radio bearer (MRB) is provided by the RRC reconfiguration, in preparation for dynamic PTM/PTP switching.

The RAN2, before a dynamic PTM/PTP switching operation, needs to confirm that the configuration of associating two logical channels with one MRB is provided by the RRC reconfiguration.

Dynamic PTM/PTP Switching Operation

Signaling

When a MRB using PTM/PTP is configured, the UE needs to monitor both the G-RNTI of the PTM leg and the C-RNTI of the PTP leg.

In LTE SC-PTM, an opportunity for SC-PTM reception is independent of the unicast DRX scheme and is an individual DRX.

Since the G-RNTI is received by a plurality of UEs, but the C-RNTI is UE-specific, two DRXs are very difficult to coordinate, so this concept can be the baseline for NR MBS.

This means that, when the UE always needs to monitor the G-RNTI, the UE needs to wake up frequently, which causes additional power consumption.

On the other hand, the UE in a connected state needs to monitor the C-RNTI for unicast reception, i.e., C-DRX, which is not an additional burden for the UE.

The UE needs to wake up on PTM leg transmissions (i.e., G-RNTI), such as on SC-MTCH in LTE SC-PTM, and also needs to wake up on PTP leg transmissions (i.e., C-RNTI), which is the same as and/or similar to when using the C-DRX.

There are four options as below for MRB reception using PTM/PTP.

Option 1: Activation/Deactivation Based Switching

The gNB indicates to the UE which leg is activated/deactivated by DCI, MAC CE, RRC signaling, or the like. The PTM and PTP legs are assumed to be associated with the PDCP layer according to the RAN2 agreement. This option is more flexible when the MBS data is received via two legs, i.e., like split bearer and PDCP packet duplication. The UE may reduce power consumption from the deactivated leg. Although the deactivation of the PTM leg is beneficial because the UE can skip G-RNTI monitoring, whether the deactivation of the PTP leg can contribute to power savings is unclear in terms of wake-up time, i.e., on-duration. The UE needs to monitor the C-RNTI according to the C-DRX as long as being in the RRC connection.

Option 2: Switching Order/Command-Based Switching

The gNB provides an indication for the UE to switch between the PTM leg and the PTP leg, for example, by the DCI, MAC CE, or RRC signaling. This option is simple and the same as and/or similar to Option 1 above. This is the same and/or similar in that the PTM leg and the PTP leg are associated with the PDCP layer according to the RAN2 agreement, and power savings can be achieved due to the deactivation of the PTM. Note that, since this option is only for switching between the PTM and PTP legs but not for activating both legs, no flexibility is exerted for the operation of the split bearer including the duplication of the PDCP packet.

Option 3: RRC Reconfiguration Based Switching

The gNB reconfigures the UE using either the PTM or the PTP as the MRB through the RRC reconfiguration. That is, the PTM leg and the PTP leg are not associated with one MRB. This is a kind of “bearer type change” that is not consistent with the RAN2 agreement because how the PDCP anchors these legs during the switching is unclear. There is also a question as to how this option can “dynamically” switch between the PTM and the PTP.

Option 4: No Signaling-Based Switching

Whenever the MRB is configured using two legs, the UE always needs to attempt receiving from both the PTM leg and the PTP leg. The two legs are anchored by the PDCP, which is in line with the RAN2 agreement. This option ensures maximum scheduling flexibility from the gNB perspective, while no opportunity to save power from the UE perspective is present.

Based on the above observations, Option 1 is most suitable in terms of scheduling flexibility, UE power consumption, and consistency with the current agreement.

Option 4 may be considered as a subset of Option 1 when the PTM leg is always activated.

For the signaling layer, the MAC CE may be simple because the activation/deactivation is primarily related to the DRX operation.

Therefore, the RAN2 needs to agree that at least the PTM leg can be activated/deactivated via the MAC CE.

The RAN2 needs to agree to introduce the MAC CE to activate/deactivate at least the PTM leg of the MRB for the dynamic PTM/PTP switching.

### INTRODUCTION

RAN2 #113-e proceeded L2 architecture design based on the e-mail discussion “[AT113-e][038][MBS] UP Architecture Decision (Chairman)”, with the following agreement.

When both the PTM and PTP are RLC-UM, configuration using PDCP anchored PTM-PTP switch without using L2 ARQ is supported (e.g., for services normally configured in the RLC UM for unicast).

In our understanding, the L2 reliability depends only on the RLC-UM in both the PTP and PTM legs, and so is not ensured in the agreement. This contribution therefore describes a conceivable solution for the L2 reliability.

### DISCUSSION

### Background

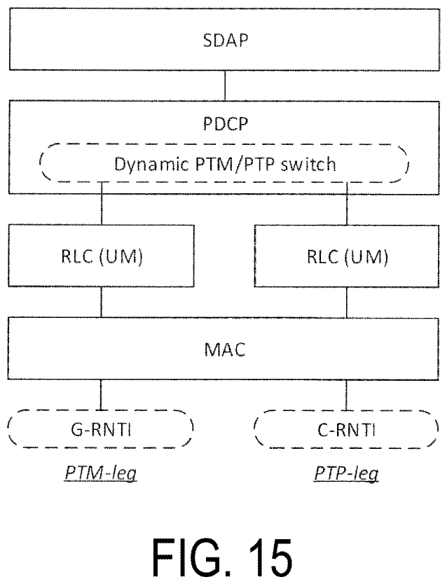

The RAN2 #113-e agreement can be represented as illustrated in FIG. 15. This is similar to the existing split bearer architecture.

In this agreement, it is explicitly stated that “both PTM and PTP are RLC-UM and are configured not to use L2 ARQ”. This means that no RLC-AM or PDCP retransmission is performed in the current architecture. Clearly, this architecture cannot contribute to increasing the L2 reliability. Thus, a reliable multicast session can only be provided by the PTP using the RLC-AM (i.e., cannot be performed without the “split bearer” architecture described above). This means that there is no improvement over conventional unicast transmission, especially in terms of spectral efficiency. Therefore, the RAN2 needs to introduce some mechanisms to enhance the L2 reliability based on Proposal 1 from the following e-mail discussion.

For A, there are the following options on the table.

A1: no L2 ARQ for PTM

A2: L2 ARQ by PDCP for PTM

A3: L2 ARQ by RLC-AM for PTM

For B, there are the following options on the table.

B1: PDCP anchored PTM/PTP switch

B2: RLC anchored PTM/PTP switch

Proposal 1: Discussion of whether to support any of the following.
For A1+B1 of PTM RLC-UM+PTP RLC-AM, some data recovery may be made in the switching procedure
A2+B1 of PTM RLC-UM+PTP RLC-AM
A3+B2 (+B1) of PTM RLC-AM+PTP RLC-AM

At this point, a reliable multicast session cannot be configured without the currently agreed PTM-PTP “split bearer” architecture, i.e., PDCP anchor, RLC-UM and L2 ARQ, but is only provided by PTP with RLC-AM, i.e., a single RLC, due to L2 reliability constraints.

The RAN2 needs to introduce additional mechanisms to enhance the L2 reliability.

A1+B1 of PTM RLC-UM+PTP RLC-AM may involve some data recovery in the switching procedure.

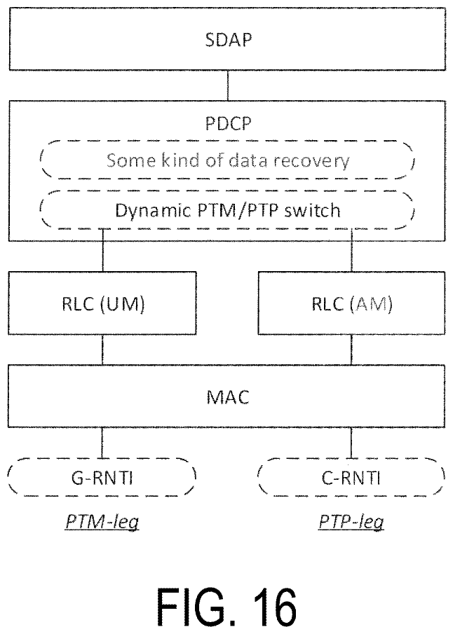

This option can be interpreted as in FIG. 16.

The L2 reliability is conceived to be ensured only by the PTP leg. For example, when the radio state is worse, data reception is switched from the PTM leg to the PTP leg. That is, the PTM leg can only be used when the radio state is good and stable.

For the A1+B1 option, the L2 reliability is ensured by the PTP leg, but the PTM leg can be used only when the radio state is good and stable. This option has limited impact on the PDCP layer since the existing RLC functionality, i.e., the AM mode of the PTP leg and the UM mode of the PTM leg are assumed to be reusable.

The A1+B1 option may have impact on the PDCP specifications, but no impact on the RLC specifications.

As indicated in the option name “some kind of data recovery in the switching procedure”, this option is assumed to be based on the current PDCP status report transmitted during the switching procedure. The PDCP status report is clearly able to be transmitted via the PTP leg instead of the PTM leg.

In the current PDCP specifications, the receiving PDCP entity triggers a PDCP status report as follows.

For AMDRB configured by a higher layer to transmit a PDCP status report in the UL (statusReportRequired in TS38.331), the receiving PDCP entity needs to trigger the PDCP status report in the following cases.
The higher layer requests PDCP entity re-establishment
The higher layer requests PDCP data recovery
The higher layer requests UL data switching
The higher layer reconfigures the PDCP entity to release DAPS and daps-SourceRelease configured in TS 38.331.

For the first condition, i.e., “the higher layer requests PDCP entity re-establishment”, the PDCP entity of the MRB (multicast radio bearer) cannot be easily re-established because a single PDCP entity in the gNB is established with a plurality of UEs, regardless of whether the single PDCP entity is associated with a PTP or PTM leg.

The second condition, i.e., “the higher layer requests PDCP data recovery”, is associated with a PDCP data recovery procedure related to UL retransmissions such as handover. Therefore, there is no association with the NR MBS since there is only DL data transmission.

For the third and fourth conditions, i.e., “the higher layer requests UL data switching” and “the higher layer reconfigures the PDCP entity to release the configured DAPS and daps-SourceRelease”, these are related to DAPS handover. Therefore, these are not used for PTM/PTP switching.

Based on the above observations, the existing conditions cannot be used for the data recovery during the PTM/PTP switching. Therefore, a new trigger condition is needed to transmit the PDCP status report. The new trigger condition may be not at the time of switching but the first packet received via an activated leg, for example, a PTP leg in the PTM/PTP switching.

For the A1+B1 option, a new trigger condition may be needed to transmit a PDCP status report (or a new PDCP control PDU for feedback) during the PTM/PTP switching. The PDCP status report is configured with an FMC indicating the First Missing COUNT and optionally a bitmap indicating per bit position whether the next PDCP SDU is successfully received or missing. In our understanding, the PDCP status report can be reused for this option but does not preclude the introduction of the new PDCP control PDU for feedback at this time.

For the A1+B1 option, the existing PDCP status report format can be reused.

A2+B1 of PTM RLC-UM+PTP RLC-AM

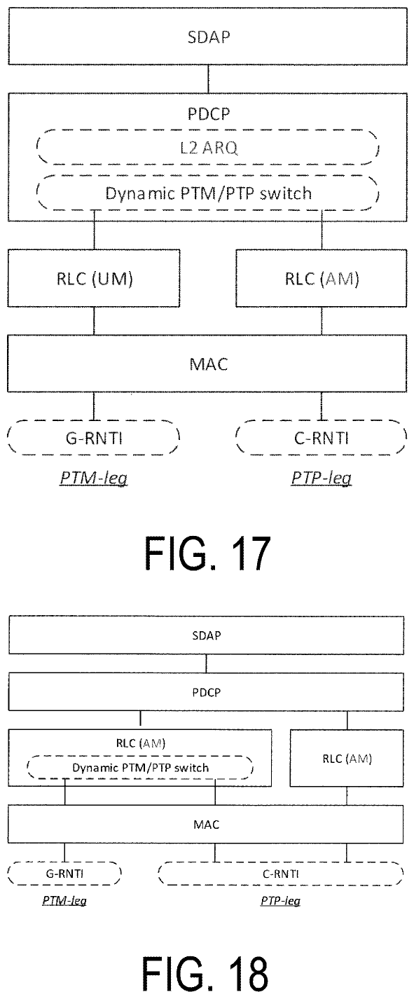

This option can be interpreted as in FIG. 17.

Either the PTM leg or the PTP leg is conceived to be used to compensate for packets missing from the PTM leg. Since the PTM leg can be used even when the radio state is relatively worse and/or unstable, the spectral efficiency is enhanced compared to the above A1+B1 option.

For the A2+B1 option, since the L2 reliability can be ensured by the PTP leg support, the PTM leg can be used even when the radio state is relatively worse and unstable. As in the A1+B1 option described above, since this option may have no impact on the RLC layer, the impact on specifications is limited in the PDCP layer.

The A2+B1 option may have impact on the PDCP specifications, but no impact on the RLC specifications. A2 is intended for “L2 ARQ by PDCP for PTM” as illustrated n FIG. 17, but the existing ARQ functionality is in the RLC layer but not in the PDCP layer. Therefore, a new ARQ functionality is clearly needed for the PDCP specifications.

For the A2+B1 option, a new ARQ functionality needs to be specified in the PDCP layer. This can be considered to be the baseline ARQ functionality of the RLC specifications. For example, refer to Section 5.3 for the procedure and 6.2.2.5 for STATUS PDU format. This is an ACK/NACK type of ARQ mechanism, and the feedback is transmitted via a STATUS PDU.

In the current RLC specifications, the STATUS PDU is triggered by two conditions below.

The AM RLC entity transmits a status PDU to an equivalent AMRLC entity to provide a positive and/or negative acknowledgment of the RLC SDUs (or a part of the RLC SDUs). A trigger to start the status report is as follows.
Polling from a peer AMRLC entity
Detection of AMD PDU reception failure

For the first condition, i.e., “polling from an equivalent AM RLC entity”, the reuse is possible because the gNB may poll one or more UEs, but a poll bit (P) field may need to be add to the PDCP data PDU.

For the second condition, i.e., “detection of AMD PDU reception failure”, this concept can be reused because the UE may detect the PDCP reception failure in some way. Currently, the detection is made by the RLC when t-Reassembly expires, but a discussion may be required for how to detect a reception failure in the PDCP. When the RLC ARQ mechanism is reused, the same and/or similar optimizations are expected in the following A3+B2 option. For example, an additional condition that forces the receive window to move or the like may be included.

For the A2+B1 option, the RLC ARQ mechanism including the STATUS PDU format can be the baseline for PDCP ARQ, but details such as how to detect a reception failure need to be changed. As another possibility, a new non-obtrusive ARQ mechanism can be considered. This can be considered as a kind of ARQ mechanism with only NACK. In this case, assuming only the FMC is reported, the current PDCP status report may be the baseline. As in the above A1+B1 option, the PDCP status report (or a new PDCP control PDU) requires a new trigger condition. As in the RLC ARQ baseline described above, a discussion may be required for how to detect a reception failure and/or how to manage a receive window when introduced.

For the A2+B1 option, the PDCP status report (or a new PDCP control PDU for feedback) may be another baseline for PDCP ARQ, but an operation related to a new trigger condition may need to be specified, such as how to detect a reception failure and/or how to manage a receive window.

A3+B2 (+B1) of PTM RLC-AM+PTP RLC-AM

This option can be interpreted as in FIG. 18.

As in the A2+B1 option described above, either the PTM leg or the PTP leg is conceived to be used to compensate for packets missing from the PTM leg. Since the PTM leg can be used even when the radio state is relatively worse and/or unstable, the spectral efficiency is enhanced compared to the above A1+B1 option. Retransmission can be performed per RLC segment. This is different from the A2+B1 option describe above for performing retransmission per PDCP SDU. Thus, this option may be considered as the best performance among the candidate options in terms of spectral efficiency.

For the A3+B2 option, since the L2 reliability can be ensured by the PTP leg support, the PTM leg can be used even when the radio state is relatively worse and unstable.

For the A3+B2 option, retransmission may be performed per RLC segment. Unlike other options, the PTP and PTM legs are anchored in the RLC layer. Therefore, this option basically has no impact on the PDCP specifications but depends on whether the above A1+B1 option is used in this option. That is, in this case, the same and/or similar impact may be expected in the PDCP specifications.

The A3+B2 option may have no impact on the PDCP specifications but depends on whether other options are used together.

The main impact is conceived to be introduced to the RLC specifications. Note that there may be no impact (or minor impact) on at least the ARQ because of being primarily dependent on the implementation of the gNB. In fact, if all UE can receive last all the missing RLC PDUs in time, the existing ARQ can be reused as it is because there is no problem with the receive window. Since retransmissions can be performed via the PTP leg in addition to the PTM leg, the PTP leg can be considered sufficiently reliable as the PTP is a basic assumption of other options related to the B 1. Note that some new conditions have been proposed to force the receive window (RX_Next) to move when an error occurs.

For the A3+B2 option, there may be no impact (or minor impact) on the RLC specifications.

### SUMMARY

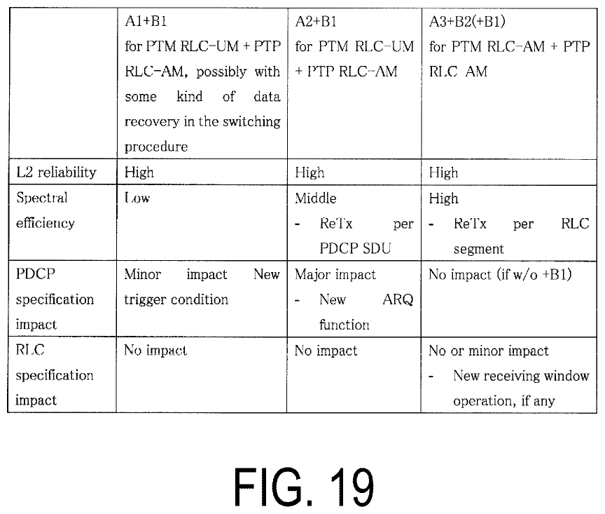

The results of the observations are summarized in FIG. 19.

The A2+B1 option is clearly less advantageous than the other options, i.e., the A1+B1 option and the A3+B2 option. The A3+B2 option can be considered as the best approach, whereas in the RAN2, “operation assumption: RLC-AM for PTM is not supported (can be reconsidered, but to change it means that the supporter of the RLC-AM for PTM needs to indicate the need)”, which needs to be reconsidered in terms of technical reasons.

The RAN2 needs to agree to introduce A1+B1 (i.e., PDCP anchor and data recovery during switching) and/or A3+B2 (i.e., PTM RLC anchor and RLC AM).

1. A communication control method used in a mobile communication system for providing a multicast broadcast service (MB S) from a base station to a user equipment, the communication control method comprising:
receiving, by the user equipment, MBS data transmitted from the base station through a transmission scheme of either Point-to-Point (PTP: unicast) transmission or Point-to-Multipoint (PTM: multicast or broadcast) transmission; and
transmitting, by the user equipment in response to switching of the transmission scheme between the PTP transmission and the PTM transmission, a message to the base station, the message comprising information indicating a sequence number of a received packet related to the switching.

2. The communication control method according to claim 1,
wherein the transmitting of the message comprises transmitting the message in response to detecting, by the user equipment, a gap in sequence numbers between the PTP transmission and the PTM transmission.

3. The communication control method according to claim 1,
wherein the switching is switching from the PTP transmission to the PTM transmission, and
wherein the message comprises information indicating a sequence number of a packet received first through the PTM transmission and/or information indicating a sequence number of a packet desired to be received last through the PTP transmission.

4. The communication control method according to claim 3, further comprising
transmitting, by the base station based on the message, one or more packets to the user equipment through the PTP transmission, the one or more packets corresponding to the gap in sequence numbers between the PTP transmission and the PTM transmission.

5. The communication control method according to claim 1,
wherein the switching is switching from the PTM transmission to the PTP transmission, and
wherein the message comprises information indicating a sequence number of a packet received last through the PTM transmission and/or information indicating a sequence number of a packet desired to be received first through the PTP transmission.

6. The communication control method according to claim 5, further comprising
determining, by the base station based on the message, a sequence number of a transmission start packet in the PTP transmission.

7. A communication control method used in a mobile communication system for providing a multicast broadcast service (MBS) from a base station to a user equipment, the communication control method comprising:
performing, by the user equipment, a PTM monitoring operation that attempts to receive MBS data transmitted from the base station via a PTM communication path; and
stopping, by the user equipment, the PTM monitoring operation in response to detecting deterioration in a measurement value indicating communication quality of the PTM communication path.

8. The communication control method according to claim 7, further comprising
transmitting, by the user equipment when stopping the PTM monitoring operation, a notification to the base station, the notification indicating stop of the PTM monitoring operation.

9. A user equipment comprising:
a processor configured to perform the communication control method according to claim 1.
